(19) United States
(12) Patent Application Publication
(10) Pub. No.: US 2024/0270212 A1
(43) Pub. Date: Aug. 15, 2024

(54) CHARGING AND CLEANING SYSTEM FOR AN ELECTRIC VEHICLE

(71) Applicant: AUDI AG, Ingolstadt (DE)

(72) Inventors: Willibald HAGN, Ingolstadt (DE); Matthias SCHNEIDER, Schernfeld (DE)

(21) Appl. No.: 18/435,396

(22) Filed: Feb. 7, 2024

(30) Foreign Application Priority Data
Feb. 14, 2023 (DE) 102023103523.1

(51) Int. Cl. B60S 3/04; B08B 3/02; B08B 3/14; B60L 53/30

(52) U.S. Cl. CPC B60S 3/04; B08B 3/02; B08B 3/14; B08B 2203/02; B60L 53/30

(57) ABSTRACT

A charging system for an electric vehicle is disclosed and may include a charging unit configured to electrically charge a traction battery of the electric vehicle and a cleaning system configured to clean an external surface of the electric vehicle. The cleaning system may comprise a cleaning unit, an arm coupled to the cleaning unit and movable relative to the cleaning unit, and a cleaning nozzle coupled to a free end of the arm. A method for operating a charging system for an electric vehicle is also disclosed.

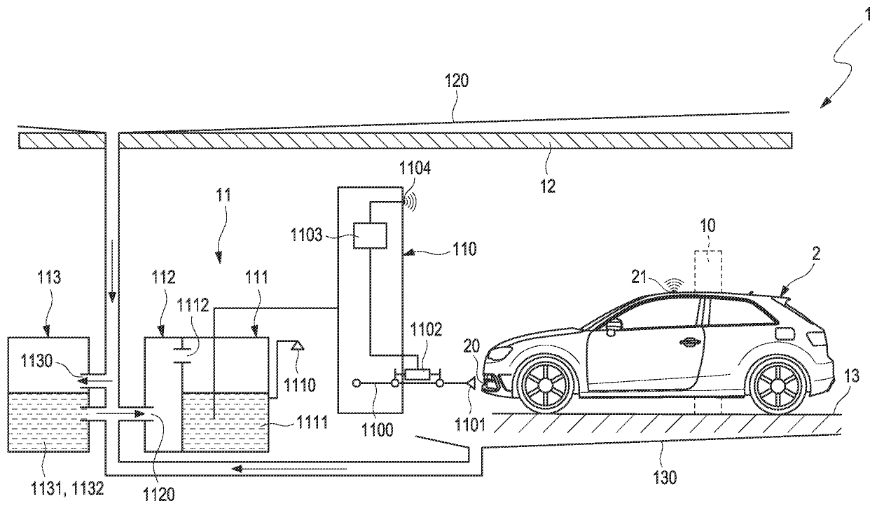

### BACKGROUND

### Technical Field

The present disclosure relates to a charging system for an electric vehicle, specifically a charging system including a charging unit and a cleaning system for cleaning an external surface of the electric vehicle. The disclosure further relates to a method for operating a charging system for an electric vehicle.

### Description of the Related Art

Charging systems including a charging unit and a cleaning system are used to charge electric vehicles and to additionally clean the vehicles during charging. Such charging systems combine a charging unit with a cleaning system to provide both functions to electric vehicles. Charging time may be used to clean the electric vehicle. As a result, the charging system may be more accurately described as a charging and cleaning system.

CN 114290941 A discloses a charging system for an electric vehicle, which includes a charging unit and a cleaning system.

An electric vehicle may also only be cleaned when visiting the charging system, i.e., the charging and cleaning functions provided by the charging system may be used independently of each other.

An autonomously driving electric vehicle may comprise a plurality of external sensors that provide environmental data for assistance systems of the electric vehicle.

The external sensors may be arranged on an outside of the electric vehicle and may be integrated into an external surface of a body of the electric vehicle.

The functionality of the assistance systems may be impaired if the external sensors are dirty and, as a result of being dirty, may provide inaccurate or no environmental data. Dirtying of the external sensors may reduce the driving safety of the electric vehicle, which is associated with an increased risk of accidents for the electric vehicle.

To avoid such a disadvantage, DE 10 2020119473 A1 and US 2018/0015908A1 each disclose a vehicle with external sensors and cleaning systems provided on the vehicle, which are provided for automatically cleaning the external sensors.

However, each external sensor of the electric vehicle needs a dedicated, i.e., exclusively assigned, cleaning system, which is technically complex, costly and also error-prone given the plurality of external sensors.

If the electric vehicle does not comprise cleaning systems for the external sensors, the external sensors must be cleaned regularly using an external apparatus, such as using a combined charging and cleaning system as described in CN 114290941 A. However, it is desirable to make cleaning the external sensors easier and to reliably achieve a better cleaning result. Additionally, the charging system should cause as little environmental impact as possible.

### BRIEF SUMMARY

Embodiments of the present disclosure may provide a charging system for an electric vehicle which is configured to enable reliably efficient cleaning of external sensors of an electric vehicle, to have a high degree of automation, and to be environmentally friendly. Further embodiments of the present disclosure may provide a method for operating a charging system for an electric vehicle.

Embodiments of the present disclosure include a charging system for an electric vehicle, which may include a charging unit configured to electrically charge a traction battery of the electric vehicle and a cleaning system configured to clean an external surface of the electric vehicle. The cleaning system may include a cleaning unit. The charging unit may be suitable for charging a purely electric vehicle, Battery Electric Vehicle (BEV) or a Plug-in Hybrid Electric Vehicle (PHEV) and generally any autonomously driving rechargeable electric vehicle. The charging unit may be a stationary charging unit, such as a charging station, or as a mobile charging unit.

The cleaning system may be suitable for cleaning Hybrid Electric Vehicles (HEV) or vehicles with internal combustion engines, which, in either case, have autonomous driving modes, i.e., which can drive at least partially autonomously.

The charging system may include a plurality of charging units. The cleaning system may comprise a plurality of cleaning units. In such embodiments, a plurality of electric vehicles may be charged and/or cleaned at the same time. The cleaning system may be arranged adjacent to the charging unit. In some embodiments, a cleaning unit and a charging unit may be integrated into one device, i.e., arranged together in the same housing.

In some embodiments of the present disclosure, the cleaning unit may include an arm positioned on the cleaning unit and movable relative to the cleaning unit and a cleaning nozzle coupled to a free end of the arm. The movable arm may enable the cleaning nozzle to be positioned and aligned relative to the electric vehicle. The arm may be configured to extend out of the cleaning unit and may be configured to retract into the cleaning unit. The cleaning unit may comprise a plurality of movable arms, each with a cleaning nozzle.

The cleaning nozzle may be configured to emit a directed spray onto the external surface of the electric vehicle. The cleaning nozzle may be associated with reliably high cleaning efficiency. The directed spray may be provided by a high-pressure pump, which may be a part of the cleaning unit, to which the cleaning nozzle is fluidly coupled, and an automatically operated valve. The valve may be integrated within the cleaning nozzle.

The cleaning unit may include one actuator or several actuators for moving the arm. The arm may be pivotably mounted on the cleaning unit and/or comprise a joint or a plurality of joints. An actuator may be associated with the pivot bearing or with each joint. Each actuator may enable the arm to move automatically and to position and align the cleaning nozzle, which enables easier cleaning of the external sensor. The actuators may operate electrically or hydraulically.

In some embodiments, the cleaning unit may include a control device functionally coupled to one or each actuator configured to one or each actuator. The controller may operate the one or more actuators to move the arm.

The cleaning unit may include a communication device functionally coupled to the control device configured to wirelessly communicate with the electric vehicle positioned in the charging system. The communication device may be configured to receive a cleaning request and data regarding the position of the external sensor from the electric vehicle and may be configured to provide this information to the control device.

The cleaning system may include a supply container separate from the cleaning unit which may be fluidly coupled to the cleaning nozzle and may be configured to provide cleaning water. The supply container may be a water tank. A quantity of the cleaning water provided with in the supply contained is larger than a quantity of water in one spray. The supply container may be fluidly coupled to several cleaning nozzles, which may be a part of several cleaning units. In other words, the supply container may be a central feature of the charging system.

The supply container may comprise a removal device or means for manually removing the cleaning water from the supply container. The removal device or means may comprise a tap coupled to the supply container and/or a fuel nozzle coupled to the supply container by way of a hose. The cleaning water arranged in the supply container may also be used for manual cleaning of the electric vehicle by way of the removal means. The cleaning water provided may also be used to refill the windshield washer system, the cooling circuit for the drive motor, the storage container of a cleaning system associated with an external sensor and the like.

The cleaning system may comprise a water treatment unit, which may be fluidly coupled on the output side thereof to an inlet of the supply container. The water treatment unit may be configured to treat water for cleaning the external sensor, i.e., to free the water from contamination that is detrimental to cleaning, such as by way of physical or chemical treatment processes.

In some embodiments, the cleaning system may include a collecting container for collecting rainwater and/or process water, which may be fluidly coupled on the output side thereof to an inlet of the water treatment unit. The collection container may be a water tank and may be a central feature in the charging system. Water collected in the collecting container may contain contamination that is detrimental to cleaning the external sensor.

The cleaning system may comprise a rainwater collection device or means arranged on a roof or configured as a roof of the charging system and/or the cleaning system may comprise a process water collection device or means arranged in a subsurface of the charging system, each of which may be fluidly coupled on the output side thereof to an inlet of the collecting container. Due to the rainwater collection device or means or the process water collection device or means, the charging system may require little or no water from a drinking water network. The process water collection device or means may enable used cleaning water to be reused. Both the rainwater collection device or means and the process water collection device or means may reduce the environmental impact of the charging system.

The present disclosure also relates to a method for operating a charging system for an electric vehicle. During normal operation of the charging system, a traction battery of the electric vehicle may be charged if the electric vehicle is coupled to a charging unit of the charging system, for example, inductively or by way of a charging cable.

In some embodiments of the present disclosure, an electric vehicle may transmit a position of an external sensor arranged on an outside of the electric vehicle to a cleaning unit of a cleaning system of a charging system. A control device of the cleaning unit may automatically move an arm movably coupled to the cleaning unit relative to the cleaning unit such that a cleaning nozzle coupled to a free end of the arm is directed at the external sensor. The cleaning nozzle may emit a spray of cleaning water to clean the external sensor. The transmitted position may enable the cleaning unit to automatically clean the external sensor. The electric vehicle may transmit a cleaning request and/or a plurality of positions to cause automatic cleaning of several external sensors.

The charging system described in the present disclosure may enable external sensors of an electric vehicle to be cleaned reliably and efficiently, may have a high degree of automation and may be environmentally friendly. The charging time of the electric vehicle may be usefully used to clean the external sensors.

### BRIEF DESCRIPTION OF THE SEVERAL VIEWS OF THE DRAWINGS

The FIGURE shows a lateral view of a charging system for an electric vehicle.

### DETAILED DESCRIPTION

The FIGURE shows a lateral view of a charging system 1 according to an embodiment of the present disclosure for an electric vehicle 2. The electric vehicle 2 may include an external sensor 20 and a communication unit 21.

The charging system 1 may include a charging unit 10 configured to electrically charge a traction battery of the electric vehicle 2. Furthermore, the charging system 1 may include a cleaning system 11 for cleaning an external surface of the electric vehicle 2.

The cleaning system 11 may include a cleaning unit 110, an arm 1100 coupled to the cleaning unit 110 and movable relative to the cleaning unit 110, and a cleaning nozzle 1101 coupled to a free end of the arm 1100. The cleaning unit 110 may include one actuator 1102 or several actuators 1102 configured to move the arm 1100. In some embodiments, the cleaning unit 110 may include a control device 1103 functionally coupled to one or each actuator 1102 configured to control one or each actuator 1102.

Furthermore, the cleaning unit 110 may comprise a communication device 1104 functionally coupled to the control device 1103 configured to wireless communicate with the electric vehicle 2 arranged in the charging system 1, such as with the communication unit 21 of the electric vehicle 2.

The cleaning system 11 may comprise a supply container 111, which may be separate from the cleaning unit 110, and which may be fluidly coupled to the cleaning nozzle 1101 such that the supply container 111 may provide cleaning water 1111. The supply container 111 may include a removal means 1110 for manually removing the cleaning water 1111 from the supply container 111.

Furthermore, the cleaning system 11 may comprise a water treatment unit 112, which may be fluidly coupled on the output side thereof to an inlet 1112 of the supply container 111.

The cleaning system 11 may include a collecting container 113 for collecting rainwater 1131 and/or process water 1132, which may be fluidly coupled on the output side thereof to an inlet 1120 of the water treatment unit 112.

Furthermore, the cleaning system 11 may comprise a rainwater collecting device 120 arranged on a roof 12 of the charging system 1 or configured as a roof 12 of the charging system 1 and/or the cleaning system 11 may comprise a process water collection device or means 130 arranged in a subsurface 13 of the charging system 1, each of which may be fluidly coupled on the output side thereof to an inlet 1130 of the collecting container 113.

The charging system may be operated in a method according to some embodiments of the present disclosure.

The electric vehicle 2 may transmit a position of the external sensor 20 arranged on an outside of the electric vehicle 2 to the cleaning unit 110 of the cleaning system 11 of the charging system 1.

The control device 1103 of the cleaning unit 110 may automatically move an arm 1100 movably coupled to the cleaning unit 110 relative to the cleaning unit 110 such that a cleaning nozzle 1101 coupled at a free end of the arm 1100 is directed at the external sensor 20. The cleaning nozzle 1101 may emit a spray of cleaning water to clean the external sensor 20.

German patent application no. 10 2023 103523.1, filed Feb. 14, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging system for an electric vehicle, comprising:
a charging unit configured to electrically charge a traction battery of the electric vehicle; and
a cleaning system configured to clean an external surface of the electric vehicle, the cleaning system comprising a cleaning unit, an arm coupled to the cleaning unit and movable relative to the cleaning unit, and a cleaning nozzle coupled to a free end of the arm.

2. The charging system according to claim 1, wherein the cleaning unit comprises at least one actuator configured to move the arm.

3. The charging system according to claim 1, wherein the cleaning unit comprises a control device functionally coupled to at least one actuator and configured to control the at least one actuator.

4. The charging system according to claim 3, wherein the cleaning unit comprises a communication device functionally coupled to the control device, the communication device configured to wirelessly communicate with the electric vehicle arranged in the charging system.

5. The charging system according to claim 1, wherein the cleaning system comprises a supply container fluidly coupled to the cleaning nozzle and configured to provide cleaning water, wherein the supply container is separate from the cleaning unit.

6. The charging system according to claim 5, wherein the supply container comprises a removal device for manually removing the cleaning water from the supply container.

7. The charging system according to claim 5, wherein the cleaning system comprises a water treatment unit, an output side of the water treatment unit being fluidly coupled to an inlet of the supply container.

8. The charging system according to claim 7, wherein the cleaning system comprises a collecting container configured to collect at least one of rainwater and process water, an output side of the collecting container being fluidly connected to the inlet of the water treatment unit.

9. The charging system according to claim 8, wherein the cleaning system comprises a rainwater collection device arranged on a roof of the charging system, an output side of the rainwater collection device being fluidly connected to the inlet of the collecting container.

10. The charging system according to claim 8, wherein the cleaning system comprises a rainwater collection device configured as a roof of the charging system, an output side of the rainwater collection device being fluidly connected to the inlet of the collecting container.

11. The charging system according to claim 8, wherein the cleaning system comprises a process water collection device arranged in a subsurface of the charging system, an output side of the process water collection device being fluidly connected to the inlet of the collecting container.

12. A method for operating a charging system for an electric vehicle, comprising:
transmitting a position of an external sensor arranged on an outside of an electric vehicle by the electric vehicle to a cleaning unit of a cleaning system of a charging system;
moving an arm movably coupled to the cleaning unit relative to the cleaning unit by a control device of the cleaning unit, such that a cleaning nozzle coupled to a free end of the arm is directed at the external sensor; and
emitting a spray of cleaning water from the cleaning nozzle, such that the cleaning water cleans the external sensor.
